(19) United States
(12) Patent Application Publication
(10) Pub. No.: US 2008/0031106 A1
(43) Pub. Date: Feb. 7, 2008

(54) Optical Pickup Apparatus

(75) Inventors: Kentaro Terashima, Kashiba-shi (JP); Takahiro Miyake, Soraku-gun (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/630,289

(22) PCT Filed: Mar. 1, 2005
(86) PCT No.: PCT/JP05/03363

§ 371 Date: Dec. 19, 2006

(30) Foreign Application Priority Data
Jul. 7, 2004 (JP) 2004-200734

(51) Int. Cl. G11B 7/00

(52) U.S. Cl. 369/44.41; 369/44.11

(57) ABSTRACT

An optical pickup apparatus includes a diffraction grating having a grating constant that is entirely uniform. The duty ratio referred to as L/G duty that is the ratio between a land L and a groove G and defined by the expression UG duty (%)=L/(L+G)×100 is continuously changed in the direction orthogonal to grating grooves of the diffraction grating. For example, the L/G duty ratio is set close to 50% in a central portion of the diffraction grating while the duty is set close to 100% in an outer peripheral portion of the diffraction grating. Accordingly, the number of components of the optical pickup is reduced while loss in light quantity in recording and reproduction can be minimized.

### TECHNICAL FIELD

The present invention relates to an optical pickup apparatus that applies light of a semiconductor laser to such an information recording medium as optical disc to record information on a recording surface of the information recording medium or to reproduce information written on the recording surface of the information recording medium.

### BACKGROUND ART

Recently, in the field of information recording researches concerning the optical information recording scheme have been conducted in various areas. The optical information recording scheme has many and various advantages including, for example, the advantage that noncontact recording and reproduction can be made and the advantage that this scheme is applicable to each of read-only, write once and rewritable storage forms. Thus, the scheme can provide low-cost and mass-storage media and accordingly the scheme has a broad range of applications being considered, including those for industrial use and those for consumer use.

As for current trends in the optical disc apparatuses, such 12-inch discs that have already been de fact standards as CD (Compact Disc) and DVD (Digital Versatile Disc) are now actively researched and developed in terms of the following three aims. The first one is to increase the information recording capacity per unit area (higher storage density), the second is to increase the speed of writing information on these de-fact-standard discs, like double-speed recording (higher transfer rate) and the third is to reduce the size of a disc and a disc reproduction apparatus without decreasing the amount of recorded information, for adaptation to mobile applications.

As means for achieving the aim of increasing the information storage capacity per unit area, which is one of the aforementioned aims, an optical pickup is actively researched and developed that uses such a short-wavelength light source as blue-violet semiconductor laser which is used typically for a Blu-ray disc (hereinafter referred to as BD), and that uses an objective lens with a numerical aperture of at least 0.8 so as to reduce a focused spot diameter. It has been found that a shorter wavelength and a larger numerical aperture than those of the conventional CD and DVD can reduce the spot size. However, since the number of optical elements used for beam shaping, optical path conversion and focusing for example is larger, the size of the optical pickup is accordingly larger than that of an optical pickup used for recording and reproduction of the conventional CD, DVD and the like.

Therefore, for future adaptation particularly to mobile applications, technical development for achieving downsizing is indispensable. Measures to downsize the pickup may include the one with which the size of each optical component is absolutely reduced and the one with which respective capabilities of at least two optical components are implemented by one component. Development of elements for the latter measures provides the downsizing effect and may further provide cost reduction. Thus, some proposals have been made as described below.

As shown in FIG. 15, an optical pickup apparatus disclosed in Japanese Patent Laying-Open No. 62-18502 uses a semiconductor laser 1 having a light-intensity distribution with a higher light intensity in a central portion and a lower light intensity in a peripheral portion. At a predetermined distance from this semiconductor laser 1, a grating lens 22 (hereinafter referred to as GL) is disposed having a blazed diffraction grating with a concentric pattern formed over at least the entire surface. GL 22 has a groove depth smaller in a central portion and larger in a peripheral portion.

Regarding the apparatus, light emitted from semiconductor laser 1 is provided as parallel +first-order diffracted light by GL 22 that is focused by an objective lens 7 on an optical disc. The diffraction efficiency of the central portion of the +first-order diffracted light generated by GL 22 is made lower than that of the peripheral portion, so that the beam intensity of the Gaussian beam emitted from the light source can be made flat. In this way, the intensity distribution excellent in focusing characteristics at objective lens 7 can be provided.

Further, as shown in FIG. 16, an optical pickup apparatus disclosed in Japanese Patent Laying-Open No. 7-262594 has a semiconductor laser 1 and a hologram optical element 15 used for the purpose of removing light with an intensity equal to or higher than a desired intensity, and optical element 15 is disposed in an optical path from semiconductor laser 1 to an objective lens 7. With this structure, regarding the forward travel, a Gaussian beam-emitted from semiconductor laser 1 passes through hologram optical element 15 and accordingly the beam intensity is made flat so that focusing characteristics at objective lens 7 can be improved. Regarding the backward travel, the light traveling backward from optical disc 8 is diffracted by the same hologram optical element 15 to be directed to a photo-receiving element for monitoring, so that an RF signal and a servo signal can be detected.

Patent Document 1: Japanese Patent Laying-Open No. 62-18502

Patent Document 2: Japanese Patent Laying-Open No. 7-262594

### DISCLOSURE OF THE INVENTION

Problems to be Solved by the Invention

Regarding the structure disclosed in Japanese Patent Laying-Open No. 62-18502, the light emitted from semiconductor laser 1 having the Gaussian intensity distribution is passed through GL 22 to make flat the light intensity distribution, and thus the focusing characteristics at objective lens 7 can be improved. However, according to this method, the light (such as zero-order light and −first-order light) except for the +first-order diffracted light generated at GL 22 is not used for focusing by the objective lens. As a result, the optical coupling efficiency deteriorates to the extent corresponding to the fact that the light intensity distribution is made flat.

Further, regarding the structure disclosed in Japanese Patent Laying-Open No. 7-262594, light that is included in the light emitted from semiconductor laser 1 and that has a desired intensity or higher is removed by diffraction, and thus the focusing characteristics at objective lens 7 can be improved, which is similar to what is disclosed in Japanese Patent Laying-Open No. 62-18502. Further, the backward-travel light is diffracted by the same hologram optical element 15 and the diffracted light is monitored, so that an RF signal and a servo signal can be detected. However, since hologram optical element 15 works for both of the forward travel and the backward travel, the quantity of light used for the servo signal accordingly decreases.

Currently, light emission characteristics of the blue-violet semiconductor laser have not become satisfactory in terms of light emission efficiency, as compared with the red and infrared semiconductor lasers used for the DVD, CD and the like. For multilayer optical discs and double-speed recording for example to be achieved in the future, the loss in light quantity in recording and reproduction has to be minimized.

Thus, the present invention has been made for solving the above-described problems. An object of the present invention is, to provide an optical pickup apparatus having a reduced number of components while the loss in light quantity in recording and reproduction can be minimized.

Means for Solving the Problems

In an aspect of an optical pickup apparatus according to the present invention, the optical pickup apparatus directs light from a semiconductor laser to an objective lens through a diffraction grating and a light splitting element, focuses the light on an optical disc by the objective lens, and couples the light reflected from the optical disc to a photo-receiving element through the objective lens and the light splitting element to optically read a record signal and a servo signal on the optical disc. The diffraction grating has an entirely uniform grating constant. A duty ratio between a land (L) and a groove (G) (hereinafter L/G duty) continuously changes from a central portion in a direction orthogonal to grating grooves of the diffraction grating toward an outer peripheral portion of the diffraction grating in the direction orthogonal to the grating grooves of the diffraction grating.

Preferably, regarding the optical pickup apparatus as described above, the L/G duty is defined by L/G duty (%)=L/(L+G)×100, the L/G duty is close to 50% in the central portion of the diffraction grating and close to 100% in the outer peripheral portion in a case where the ratio of the land increases as the distance to the outer peripheral portion decreases in the direction orthogonal to the grating grooves of the diffraction grating or close to 0% in the outer peripheral portion in a case where the ratio of the groove increases as the distance to the outer peripheral portion decreases in the direction orthogonal to the grating grooves of the diffraction grating.

More preferably, regarding the optical pickup apparatus as described above the semiconductor laser is disposed in a manner that a plane of polarization of light emitted from the laser is perpendicular to the direction of the grating grooves of the diffraction grating.

In another aspect of the optical pickup apparatus according to the present invention, the optical pickup apparatus directs light from a semiconductor laser to an objective lens through a diffraction grating and a light splitting element, focuses the light on an optical disc by the objective lens, and couples the light reflected from the optical disc to a photo-receiving element through the objective lens and the light splitting element to optically read a record signal and a servo signal on the optical disc. The diffraction grating has an entirely uniform grating constant. A duty ratio between a land (L) and a groove (G) (hereinafter L/G duty) continuously changes from a central portion in a direction parallel to grating grooves of the diffraction grating toward an outer peripheral portion of the diffraction grating in the direction parallel to the grating grooves of the diffraction grating.

Preferably, regarding the optical pickup apparatus as described above, the L/G duty is defined by L/G duty L(%)=L/(L+G)×100, the L/G duty is close to 50% in the central portion of the diffraction grating, is close to 100% in the outer peripheral portion in a case where the ratio of the land increases as the distance to the outer peripheral portion decreases in the direction parallel to the grating grooves of the diffraction grating and is close to 0% in the outer peripheral portion in a case where the ratio of the groove increases as the distance to the outer peripheral portion decreases in the direction parallel to the grating grooves of the diffraction grating.

More preferably, regarding the optical pickup apparatus as described above, the semiconductor laser is disposed in a manner that a plane of polarization of light emitted from the laser is parallel to the direction of the grating grooves of the diffraction grating.

Still more preferably, regarding the optical pickup apparatus as described above, the diffraction grating has a land width and a groove width that linearly change from the central portion toward the outer peripheral portion.

Still more preferably, regarding the optical pickup apparatus as described above, the diffraction grating is provided on a plane on which light is incident or a plane from which light is emitted of a diffraction element, and the diffraction grating generates diffracted light used for tracking servo.

Still more preferably, regarding the optical pickup apparatus as described above, the diffraction grating is disposed in an optical path from the semiconductor laser to the light splitting element.

Still more preferably, regarding the optical pickup apparatus as described above, the diffraction grating satisfies a relation 0.6≦D/φgr≦1 between a diffraction region width D in the direction in which the L/G duty changes and an effective diameter φgr, at a diffraction grating position, of the light from the semiconductor laser.

Still more preferably, regarding the optical pickup apparatus as described above, the diffraction grating satisfies a relation 1.8≦δc/δ≦2 between a diffraction efficiency of ±first-order light in a center part and a diffraction efficiency δ of ±first-order light of a whole effective light beam.

### EFFECTS OF THE INVENTION

The optical pickup apparatus according to the present invention has a reduced number of components while the loss in light quantity in recording and reproduction can be minimized.

### BRIEF DESCRIPTION OF THE DRAWINGS

FIG. 1 shows an optical system of an optical pickup apparatus according to a first embodiment of the present invention, illustrating the optical system as an example that has a diffraction grating disposed between a collimate lens and a light splitting element.

FIG. 2 shows a grating pattern of the diffraction grating as well as an effective beam diameter of light from a light source, and (b) and (c) each show an enlarged view of a portion of the diffraction grating shown by (a).

FIG. 3 is a graph illustrating calculation, in a simulation, of the diffraction efficiency with respect to the L/G duty of the diffraction grating.

FIG. 4 is a graph showing the value of the diffraction efficiency with respect to displacement in the Y direction (track direction of an optical disc).

FIG. 5 is a graph showing a change in intensity profile of emitted light with respect to the amplitude of diffraction of the diffraction grating.

FIG. 6 is a graph showing an intensity distribution with respect to displacement in the Y direction of zero-order diffracted light before and after a beam emitted from a semiconductor laser of the optical pickup apparatus is passed through the intensity correcting diffraction grating.

FIG. 7 is a graph showing a change in Rim intensity with respect to the width in the Y direction (track direction) of a grating region of the diffraction grating.

FIG. 8 shows an optical system of an optical pickup apparatus according to a second embodiment of the present invention, illustrating the optical system as an example that has a diffraction grating disposed between a semiconductor laser and a light splitting element.

FIG. 9 shows a grating pattern of the diffraction grating as well as an effective beam diameter of light from a light source, and (b) and (c) each show an enlarged view of a portion of the diffraction grating shown by (a).

FIG. 10A is an enlarged view of the optical system around the diffraction grating.

FIG. 10B shows a laser-light-irradiated region and an effective beam diameter on the diffraction grating.

FIG. 11 is a graph showing an intensity distribution in the X direction (tracking direction) and the Y direction (track direction) after light is passed through the diffraction grating.

FIG. 12A is an enlarged view of an optical system around a diffraction grating according to a third embodiment.

FIG. 12B shows a laser-light-irradiated region and an effective beam diameter on the diffraction grating.

FIG. 13 shows a grating pattern of the diffraction grating as well as an effective beam diameter of light from a light source, and (b) and (c) each show an enlarged view of a portion of the diffraction grating shown by (a).

FIG. 14 is a graph showing an intensity distribution in the X direction (tracking direction) and the Y direction (track direction) after light is passed through the diffraction grating.

FIG. 15 illustrates a structure of an optical pickup of a conventional art.

FIG. 16 illustrates a structure of an optical pickup of a conventional art.

### DESCRIPTION OF THE REFERENCE SIGNS

1 semiconductor laser, 2 collimate lens, 3 diffraction grating, 4 light splitting element, 5 spherical aberration compensation element, 6 reflecting mirror, 7 objective lens, 8 optical disc, 9 collective lens, 10 cylindrical lens, 11 photo-receiving element, 20 diffraction element

### BEST MODES FOR CARRYING OUT THE INVENTION

### First Embodiment

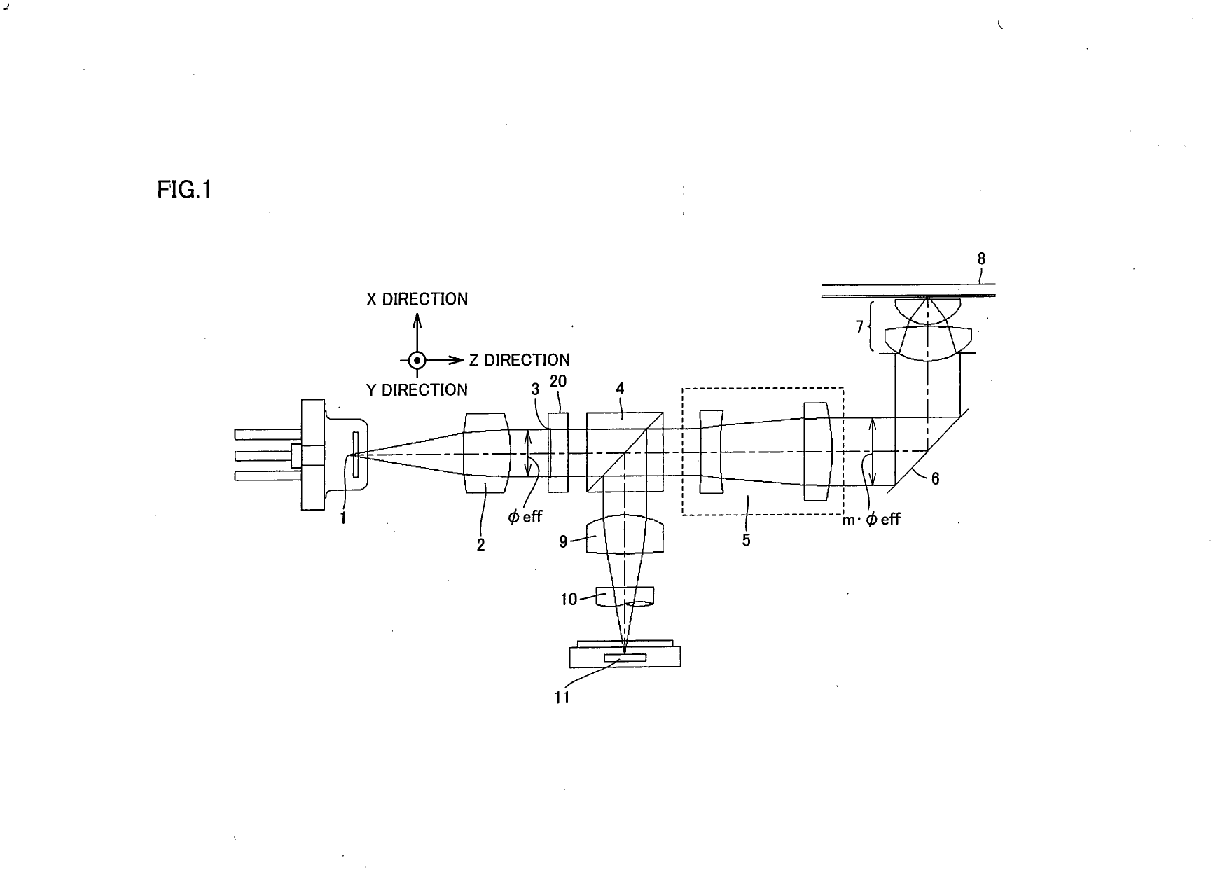

In the following, an optical pickup apparatus according to a first embodiment is described with reference to FIGS. 1 to 7.

As shown in FIG. 1, light emitted from a semiconductor laser 1 is converted by a collimate lens 2 into a parallel beam having an effective beam diameter of φeff (2 mm in the present embodiment). After this, the light beam travels through a diffraction grating 3 and a light splitting element 4, and thereafter the effective beam diameter is enlarged by m times by a spherical aberration compensation element 5 comprised of two lenses. In the present embodiment, m=1.5 is used and thus the effective beam diameter of the light having traveled through spherical aberration compensation element 5 is φeff·m=3 mm. Further, the optical path of the light beam is changed by a reflecting mirror 6 and then the light beam is directed to an objective lens 7 comprised of a set of two lenses, and focused on an optical disc 8.

The light reflected from optical disc 8 travels through objective lens 7 and thereafter travels along an optical path which is the reverse one relative to the optical path of the incident light. The light is then reflected by light splitting element 4, and passed through a collective lens 9 and a cylindrical lens 10 and thereby provided with astigmatism. Then, a photo-receiving element 11 detects, on the optical disc, a record signal, a focus servo signal using the astigmatism method and a tracking servo signal using ±first-order diffracted light generated by diffraction grating 3 on the forward travel of the light.

Although diffraction grating 3 is illustrated as the one disposed on the surface of diffraction element 20 that faces the light source, it is not limited to the illustrated one. Alternatively, the diffraction grating may be disposed on the surface of diffraction element 20 that faces light splitting element 4. Further, while objective lens 7 in FIG. 1 uses a set of two lenses, a single lens may be used instead of the objective lens having a set of two lenses as means for achieving the purpose thereof. Further, spherical aberration compensation element 5 aims to correct spherical aberration due to an error in cover glass thickness, and a liquid crystal drive element may be used for achieving the aim.

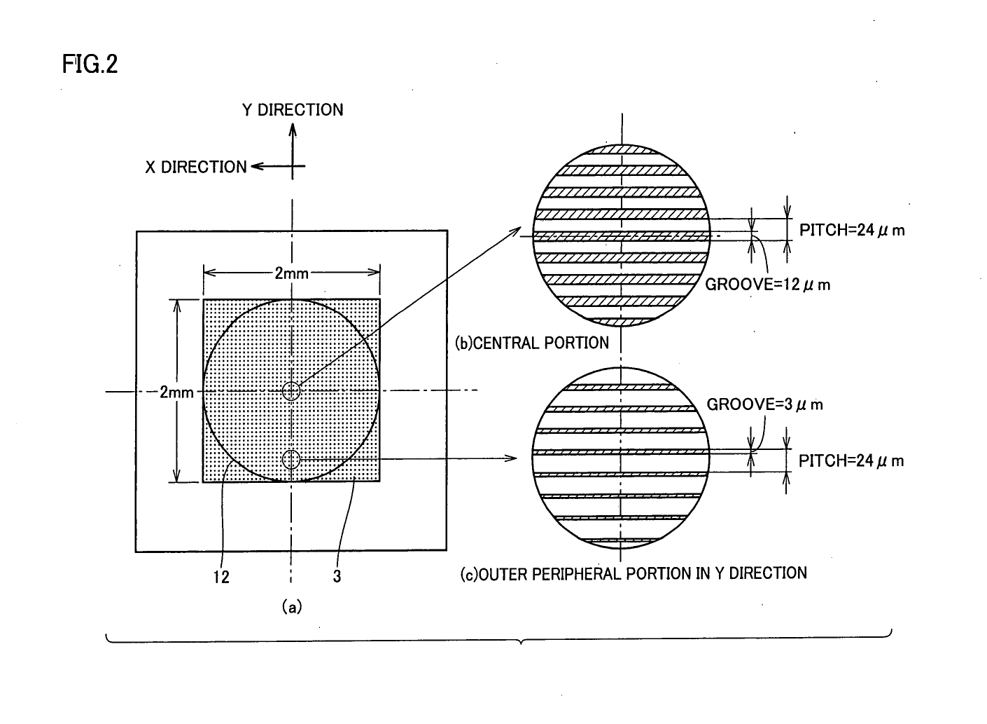

In the present embodiment, in the optical path from collimate lens 2 to light splitting element 4, diffraction grating 3 having a predetermined pattern is provided. Regarding diffraction grating 3, as shown in FIG. 2, grating grooves are parallel to the X direction (tracking direction). Further, the L/G duty which is the duty ratio between a land (L) and a groove (G) and is defined by the expression: L/G duty (%)=L/(L+G)×100 linearly changes in the Y direction (track direction). The duty ratio in a central portion of diffraction grating 3 is close to 50%, and is closer to 100% as the distance to the outer periphery decreases and the land ratio increases. In the embodiment shown in FIG. 2, it is supposed that diffraction grating 3 has a groove pitch of 24 μm, the groove width in the central portion is 12 μm (land width is 12 μm), and the groove width in an outer peripheral portion in the Y direction is 3 μm (land width is 21 μm). Here, as for the L/G duty, the land ratio increases, as the distance to the outer periphery decreases, in the manner that the L/G duty is line-symmetric about the central axis at the central portion of diffraction grating 3. In the present embodiment, the land ratio increases as the distance to the outer periphery decreases. Alternatively, the groove ratio may be increased as the distance to the outer periphery decreases. In this case, the L/G duty is close to 0% in the outer peripheral portion.

Further, semiconductor laser 1 is disposed in the manner that the plane of polarization of the light is orthogonal to the direction of the grooves of diffraction grating 3. Regarding diffraction grating 3 of the present embodiment, it is supposed that the pitch interval on diffraction grating 3 is 24 μm and the main-sub spot distance of optical disc 8 is 20 μm.

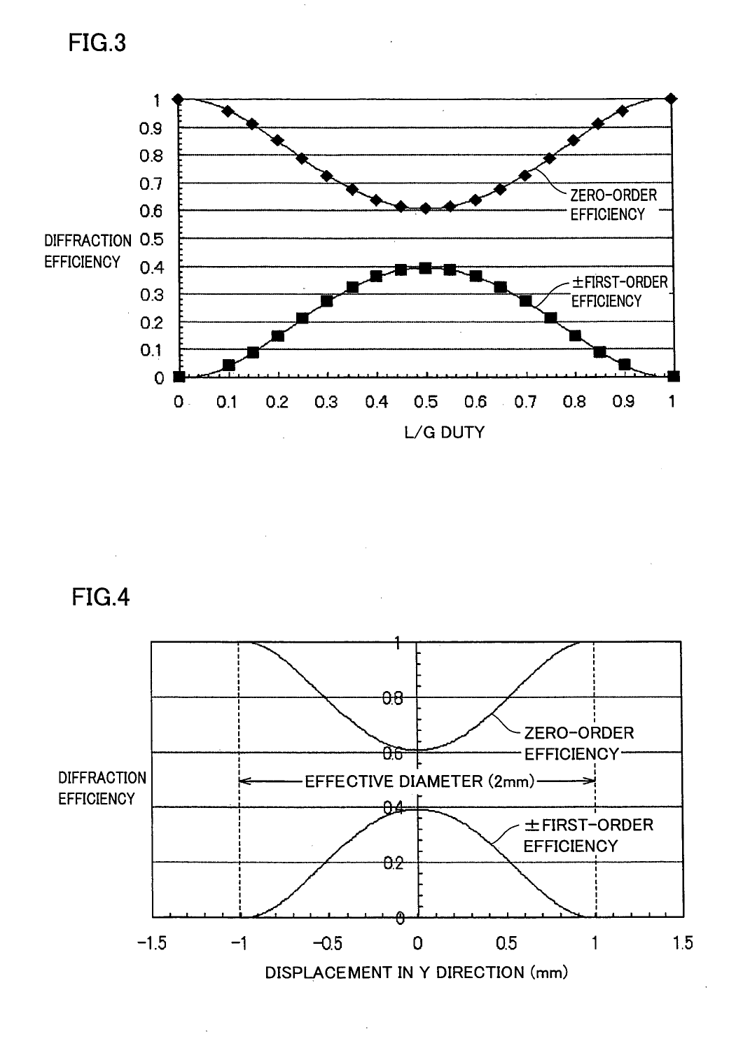

A change in diffraction efficiency of zero-order diffracted light and ±first-order diffracted light as the L/G duty-thus changes is determined through an optical simulation, and the results are shown in FIG. 3. The zero-order diffraction efficiency is a minimum when the L/G duty is 50%, while the ±first-order diffraction efficiency is a maximum. It is noted that, in calculation for the diffracted light, actually such higher-order diffracted light as ±second-order diffracted light is also generated. However, for the sake of convenience herein, higher-order diffracted light is ignored, and the total quantity of the zero-order light and the ±first-order light is used as a standardized light quantity. It is noted that the simulation uses optical simulation software based on the wave optics and optical parameters used for the calculation are as follows; the light source wavelength is 405 nm, a grass material for the diffraction element is quartz glass, and the grating depth is 200 nm.

In the case where the L/G duty is different between the central portion and the outer peripheral portion as shown in FIG. 2, the diffraction efficiency of the zero-order diffracted light is lower in the central portion where the L/G duty of the diffraction grating is close to 50%, and higher in the outer peripheral portion where the L/G duty is close to 100%. In contrast, the diffraction efficiency of the ±first-order diffracted light is higher in the central portion where the L/G duty of the diffraction grating is close to 50%, and lower in the outer peripheral portion where the L/G duty is close to 100%. Even in the case where the L/G duty is close to 0% in the outer peripheral portion, the diffraction efficiency of the zero-order diffracted light is lower in the central portion where the L/G duty of the diffraction grating is close to 50% and higher in the outer peripheral portion where the L/G duty is close to 0%. Similarly, the diffraction efficiency of the ±first-order diffracted light is higher in the central portion where the L/G duty of the diffraction grating is close to 50% and lower in the outer peripheral portion where the L/G duty is close to 0%. Therefore, regardless of whether the L/G duty is closer to 100% as shown in FIG. 2 or the L/G duty is closer to 0% as the distance to the outer periphery decreases, the zero-order diffracted light has a downwardly protruding profile while the ±first-order diffracted light has an upwardly protruding profile with respect to displacement in the Y direction, as shown in FIG. 4.

According to the diffraction-efficiency profiles shown in FIG. 4, the quantity of generated ±first-order light (6) is 20.4%. Here, δ is defined as the ratio of generated ±first-order light in total to the total light intensity within the effective diameter. Further, the maximum value (δc) of the ±first-order light in the central portion of diffraction grating 3 is 39%. Thus, the ratio between them is δc/δ=1.91.

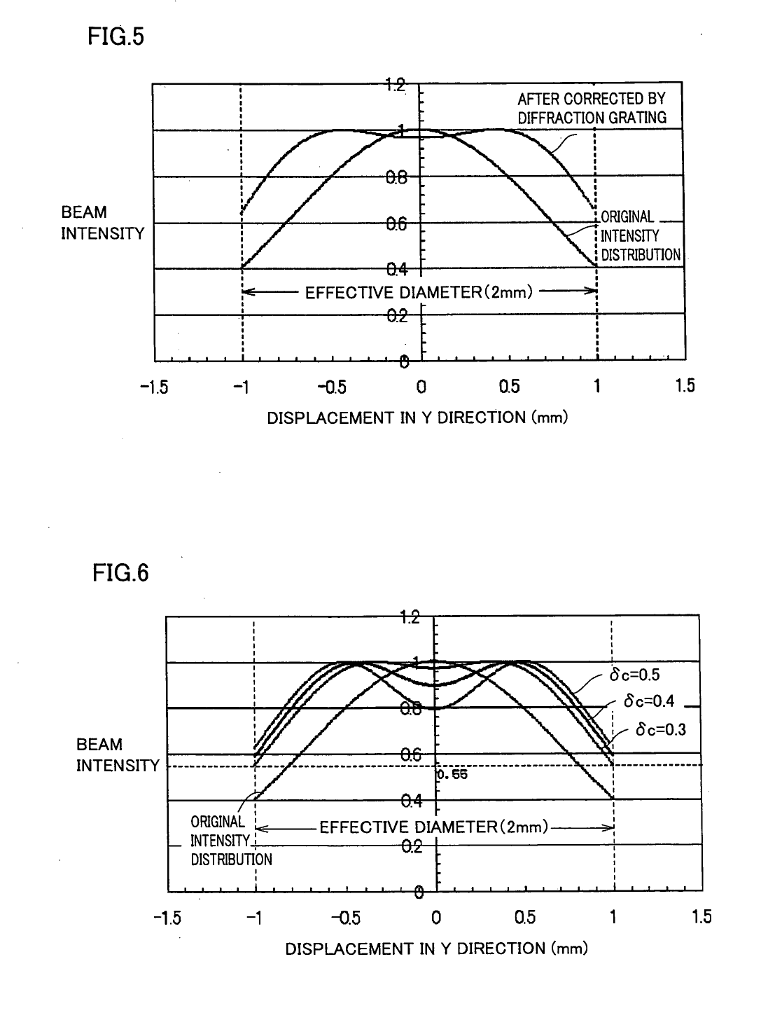

As shown in FIG. 5, in the case where the intensity profile of incident light is a Gaussian profile, the amplitude of the diffraction efficiency having an inverse Gaussian profile causes the intensity profile of the emitted beam to greatly change. Further, as shown in FIG. 6, as δc changes from 30% to 50%, the Rim intensity increases. Here, the Rim intensity is the intensity at a pupil edge with respect to a maximum intensity represented by 100% at a point of an entrance pupil corresponding to the aperture of objective lens 7. When the Rim intensity is 0%, the Gaussian beam passes through the whole aperture, including a low-intensity portion in the peripheral region. On the contrary, when the Rim intensity is 100%, the beam is a plane-wave beam having a uniform intensity. Therefore, as the Rim intensity is higher, the focused spot diameter of objective lens 7 will be smaller.

As for the coupling-efficiency of the main beam (zero-order light) with respect to the objective lens, the coupling efficiency decreases like 84.3% (δc=0.3), 76.4% (δc=0.45), 73.8% (δc=0.5), as δc increases. In terms of the relation with the standard or the like of the Rim intensity, a required minimum Rim intensity is supposed to be 55% or higher, and a required minimum coupling efficiency with respect to the objective lens is supposed to be 75% or higher. The values are different to some degree depending on the optical system. The efficiency of the first order light that is a sub beam for the conventional optical pickup of the applicant should be approximately 20%. Further, in consideration of various margins including displacement of the objective lens for example, the efficiency of the ±first-order light is supposed to be 25% or lower. Therefore, in order to ensure the required minimum Rim intensity and the required minimum coupling efficiency with respect to the objective lens, the relation 0.3≦δc≦0.45 has to be satisfied. With standardization using the quantity of generated ±first-order light (δ), the relation is 1.8≦δc/δ≦2. Therefore, it is necessary to satisfy the above-described relation in order to ensure the required minimum Rim intensity and the required minimum coupling efficiency with respect to the objective lens.

As shown in FIG. 6, by passing light having an effective beam diameter of 2 mm through a diffraction element having such a diffraction profile as described above, the original intensity distribution having a single peak with respect to displacement in the Y-direction can be changed to an intensity distribution having a plurality of peaks (for the sake of convenience, the intensity distribution is standardized using the maximum intensity). The intensity distribution is thus changed and accordingly the zero-order light intensity near the central portion can relatively be decreased without using a shaping prism as employed in the conventional art. Thus, the Rim intensity of the original intensity distribution that is 40% can be increased to 60% or higher.

For the BD, in order-to sufficiently decrease the focused spot size, it is necessary to have a Rim intensity of 60% or higher in the tracking direction (X direction) of optical disc 8 and have a Rim intensity of 55% or higher in the track direction (Y direction). As means for obtaining the sufficiently small focused spot, the technique of changing the L/G duty from the central portion toward the peripheral portion is effective.

As for the original light, the original light passed through the diffraction grating is split into the zero-order diffracted light and the ±first-order diffracted light. For example, when light having an effective beam diameter of 2 mm is passed through a diffraction grating having the shape as shown in FIG. 2(a), the zero-order coupling efficiency is 79.6%. The zero-order coupling efficiency is represented by the following expression supposing that the split ratio of the diffraction grating is sub:main:sub=1:r:1 (r>1).
zero-order coupling efficiency (%)=r/(r+2)×100

If it is necessary, for performing tracking using the three-beam method, that the ratio of the ±first-order light used as the sub beam is 15% or higher with respect to the entire light, a sub-beam light exceeding the ratio will be unnecessary. Therefore, in this case, the sub beam intensity is 20.4% (=100−79.6) and thus the light of 5.4% is excessively applied. Therefore, the excessive light may be used as a main beam so that the RF signal level can be improved.

One method for increasing the main beam intensity may be to limit the region in the Y direction of the diffraction grating and allow light outside the diffraction grating to pass. This method can be used to reduce a loss of the zero-order light to the extent corresponding to the increased area for passing the light. For example, in an optical simulation using a diffraction region having a width in the Y direction of 1.3 mm (65% of the effective diameter), the coupling efficiency of the zero-order light can be improved to 80.1% and, when the width is 1.2 mm (60% of the effective diameter), the coupling efficiency of the zero-order light can be improved to 80.5%. In the simulation, the optical simulation software as described above is used, and the optical parameters include the above-described values and additionally a horizontal component (θ//) of 9° of the whole half-width of a far field pattern (hereinafter referred to as FFP) of the light emitted from the semiconductor laser, a vertical component (θ⊥) of 18° thereof, and a focal length of the collimate lens of f=8.1 mm that are used for calculation.

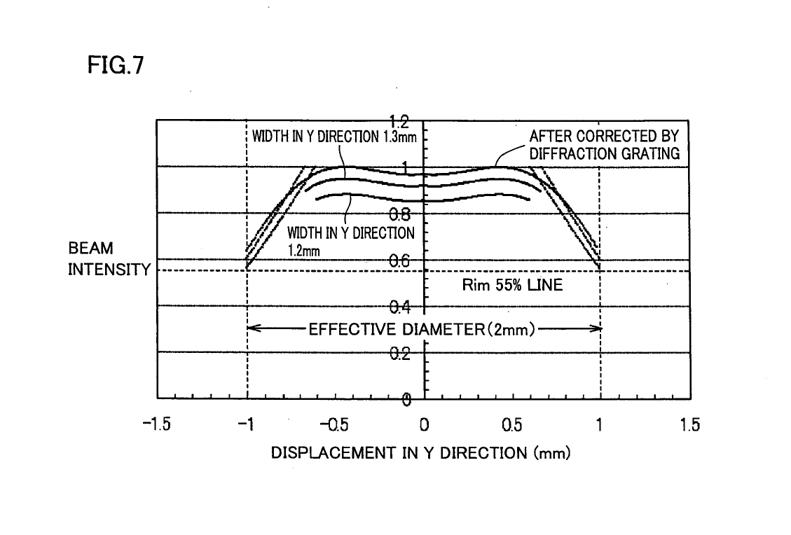

If the region in the Y direction is further narrowed, an increase in coupling efficiency of the zero-order light is expected. However, as shown in FIG. 7, the Rim intensity is decreased by narrowing the region in the Y direction. When the width of the region in the Y direction is narrowed to 1.1 mm (55% of the effective diameter), the Rim intensity with respect to the effective diameter of the objective lens is 55% or lower. This is for the reason that the intensity in a boundary region is at its maximum and thus a variation after standardization is large in an outer peripheral portion. It is seen from the above that the region of the diffraction grating can be limited to improve the coupling efficiency of the zero-order light and additionally the width of the diffraction region can be set to a predetermined magnitude to obtain a satisfactory Rim intensity value. For satisfying the Rim intensity indispensable for improving focusing characteristics of the objective lens, the width in the Y direction of the diffraction region has to be set to 60% or higher of the effective diameter.

Further, if the width of the diffraction region is excessively increased, a loss in light quantity occurs. Therefore, the width of the diffraction region has to be identical to or smaller than the effective diameter at the grating position. Thus, between the width (D) in the Y direction of the diffraction region and the effective diameter (φgr) at the diffraction grating position, there is the following relation.
0.6≦D/φgr≦1

Diffraction grating 3 of the present embodiment is disposed in the parallel optical path. In the case where the pitch interval on the diffraction grating is 24 μm, the main-sub spot interval on the optical disc is 20 μm.

### Second Embodiment

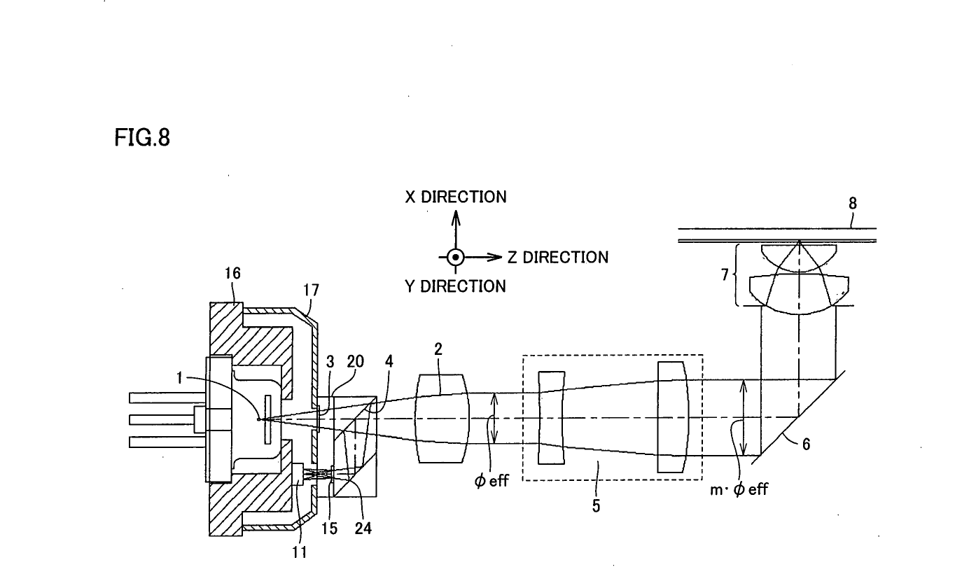

In the following, a second embodiment is described with reference to FIGS. 8 to 11.

As shown in FIG. 8, light from semiconductor laser 1 is passed through diffraction grating 3 and light splitting element 4 and converted by collimate lens 2 into a parallel beam having an effective beam diameter of φeff (2 mm in the present embodiment). After this, the effective beam diameter is enlarged by m times by spherical aberration compensation element 5 comprised of two lenses. In the present embodiment, m=1.5 is used and thus the effective beam diameter of the light having traveled through the spherical aberration compensation element is φeff·m=3 mm. Further, the light beam has its optical path changed by reflecting mirror 6 and is directed to objective lens 7 comprised of a set of two lenses and focused on optical disc 8.

The light reflected from optical disc 8 is passed through objective lens 7 and thereafter the light travels along an optical path which is the reverse one relative to the optical path of the incident light. Then, the light is focused by collimate lens 2 and thereafter reflected by light splitting element 4 and a mirror 24. After this, the light is split by a hologram 15, and photo-receiving element 11 detects, on the optical disc, a record signal, a focus servo signal and a tracking servo signal using ±first-order light generated by diffraction grating 3 in the forward travel of the light.

Although the diffraction grating in FIG. 8 is illustrated as the one disposed on the surface of diffraction element 20 that faces the light source, it is not limited to the illustrated one. Alternatively, the diffraction grating may be disposed on the surface of diffraction element 20 that faces light splitting element 4. Further, while objective lens 7 illustrated in FIG. 8 uses a set of two lenses, an optical system using a single lens may be employed as described in connection with the first embodiment. Further, spherical aberration compensation element 5 used for spherical aberration may be configured using a liquid crystal drive element as described in connection with the first embodiment.

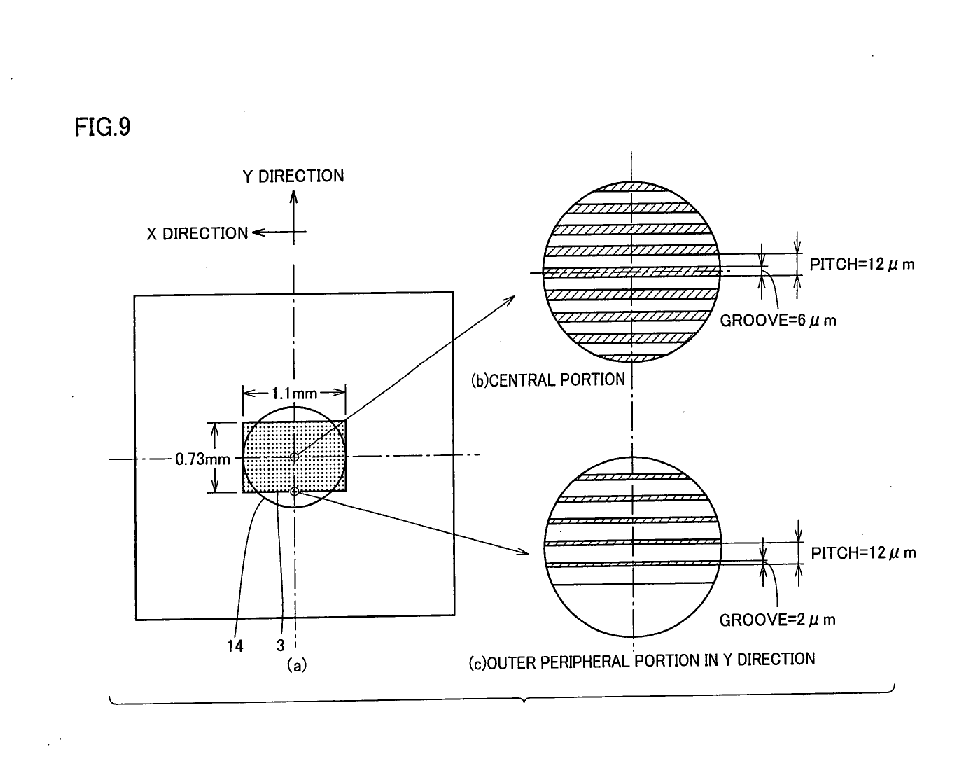

In the present embodiment, diffraction grating 3 having a predetermined pattern is provided in the optical path from semiconductor laser 1 to light splitting element 4. Regarding this diffraction grating, as shown in FIG. 9, the direction of grooves of the diffraction grating is parallel to the X direction (tracking direction). Further, the L/G duty changes linearly in the Y direction (track direction). The L/G duty is close to 50% in a central portion and close to 100% as the distance to the outer periphery decreases and the land ratio increases. Further, semiconductor laser 1 is disposed in the manner that the plane of polarization of the emitted light is orthogonal to the direction of grooves of the diffraction grating. For diffraction grating 3 of the present embodiment, the pitch interval on the diffraction grating is set to 12 μm so that it is equal to the main-sub spot distance on the optical disc of the first embodiment.

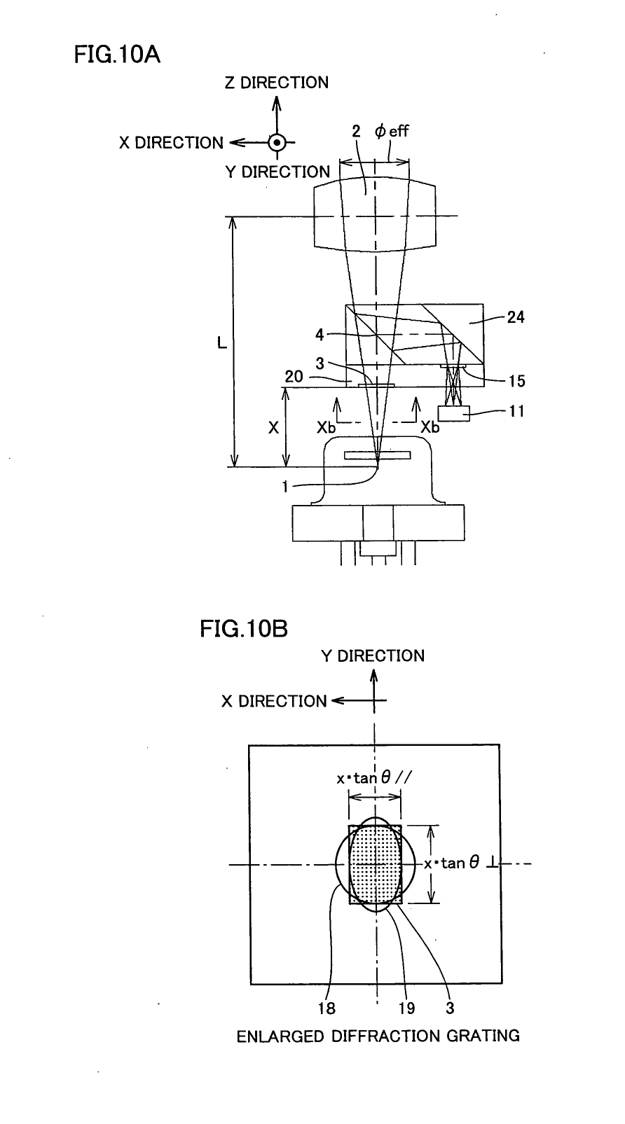

An enlarged view of an optical system around the diffraction grating, and a region where the laser light is applied and the effective beam diameter on the diffraction grating are shown in FIGS. 10A and 10B. In the present embodiment, diffraction grating 3 is disposed in a convergence optical path from semiconductor laser 1 to collimate lens 2. Therefore, supposing that the optical path length from semiconductor laser 1 to a main surface of collimate lens 2 is L and the optical path length from semiconductor laser 1 to the surface of the diffraction grating 3 is x, the effective diameter (φgr) on the surface of diffraction grating 3 is determined by the following expression.
φgr=(x/L)·φeff

Thus, in the case where L=8.1 mm and x=4.5 mm are used, the effective diameter at the position of the diffraction grating is φgr=1.1 mm as determined by the expression above. FIG. 10B shows an effective beam diameter 18 and a laser-beam irradiated region 19 on diffraction grating 3. Supposing that the whole half-width of the FFP of the light emitted from semiconductor laser 1 has a horizontal component of θ// and a vertical component of θ⊥, an elliptical laser-irradiated region having x·tan θ⊥ in the X direction (tracking direction) and x·tan θ// in the Y direction (track direction) is formed. For example, in the case where θ//=9° and θ⊥=18° are provided, the irradiated region is elliptical in shape that is long in the X direction and has a minor axis of 0.7 mm and a major axis of 1.43 mm. The effective beam diameter (φgr) at the position of diffraction grating 3 uses a central portion of the laser-irradiated region.

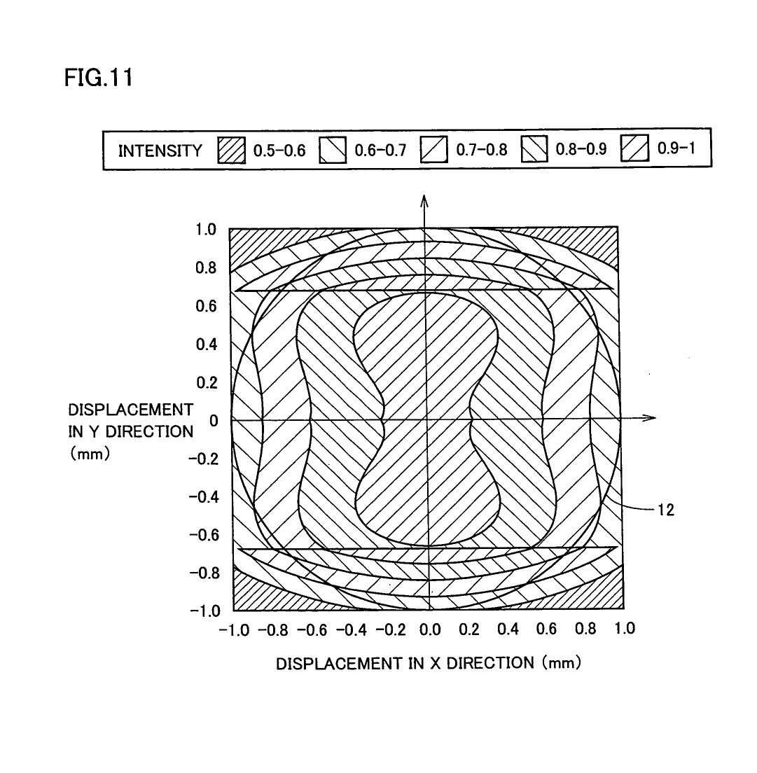

The intensity distribution of the light passed through diffraction grating 3 and thereafter emitted from the collimate lens is shown in the form of a graph in FIG. 11. Around the central part, iso-intensity distribution lines extend in the shape of a dumbbell and oriented in the Y direction. Further, the line representing an intensity of 0.6 or higher is elliptical in shape and oriented in the Y direction. This is for the reason that the FFP irradiation pattern in FIG. 10B is elliptical. At Y=±0.7 mm, a borderline is shown because of the borderline of the diffraction grating.

By passing the light through the diffraction grating as described above, the Rim intensity in the Y direction (track direction) can be increased from 40% to 60% without a shaping prism through which the light is passed as used in the conventional art. Further, the width (D) in the Y direction of the diffraction region is set to φgr×0.6≦D≦φgr as the first embodiment, and thus a satisfactory intensity of the main beam applied to the objective lens can be ensured and further a satisfactory Rim intensity is met. Therefore, an optical system excellent in focusing characteristics of the objective lens can be designed.

In accordance with the first and second embodiments of the present invention as described above, the optical pickup apparatus directs light from the semiconductor laser where a plane of polarization of the light emitted from the light source is adjusted to the one that is perpendicular to the direction of grating grooves of the diffraction grating, the optical pickup apparatus directs the light through the objective lens and the light splitting element and thereafter through the collective lens to couple the light with the photo-receiving element and thereby optically read a record signal and a servo signal on the optical disc. The grating constant of the diffraction grating is entirely uniform, the L/G duty continuously changes in the direction orthogonal to grating grooves of the diffraction grating, the L/G duty is close to 50% in the central portion of the diffraction, grating while the duty is close to 100% as the distance to the outer periphery decreases and the land ratio increases (the duty is close to 0% as the groove ratio increases). Therefore, without separately using such an optical component as shaping prism, the intensity of the Gaussian beam emitted from the semiconductor laser can be made flat. Further, the focused spot on the optical disc is made sufficiently small, and thus the quality of record and reproduction signals can be improved.

Further, the zero-order light near the central portion that is reduced for the purpose of making flat the intensity of the Gaussian beam is converted into ±first-order light to be used for tracking servo by the diffraction grating, and thus the light can efficiently be used as compared with the conventional optical pickup.

Furthermore, the diffraction grating is disposed in the optical path from the semiconductor laser to the light splitting element, and thus the diffraction grating can be disposed in only the path of the forward-traveling light. Accordingly, a loss of the light is smaller as compared with the conventional pickup so that the light can efficiently be used.

Moreover, the region of the diffraction grating is restricted and thus a satisfactory intensity of the main beam applied to the objective lens can be ensured and a satisfactory Rim intensity is also met. Accordingly, an optical system excellent in focusing characteristics of the objective lens can be designed.

### Third Embodiment

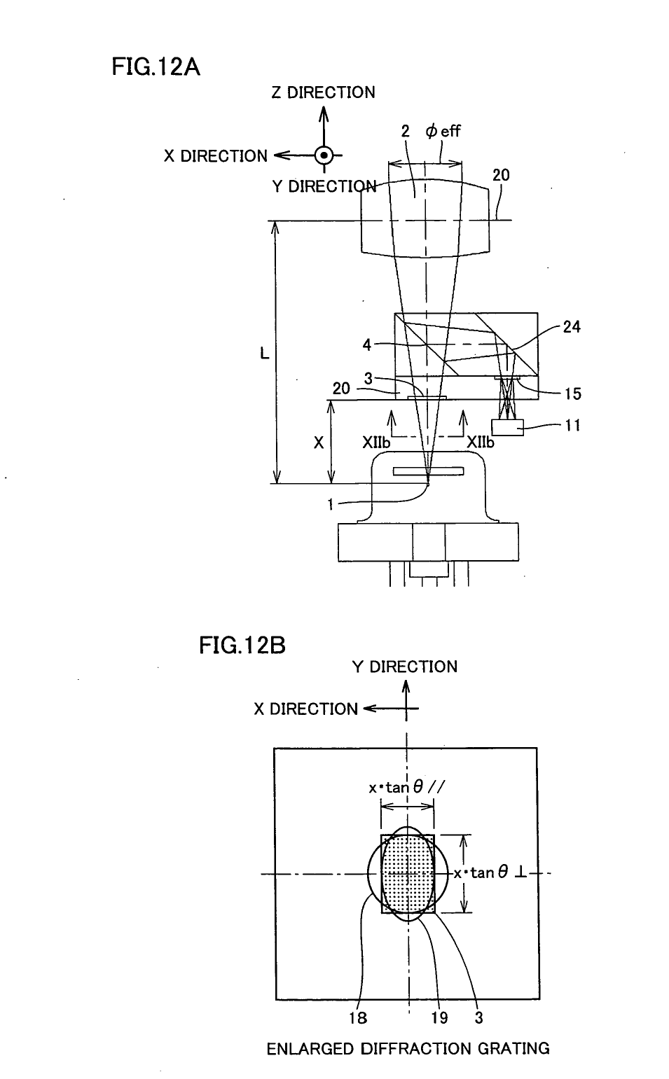

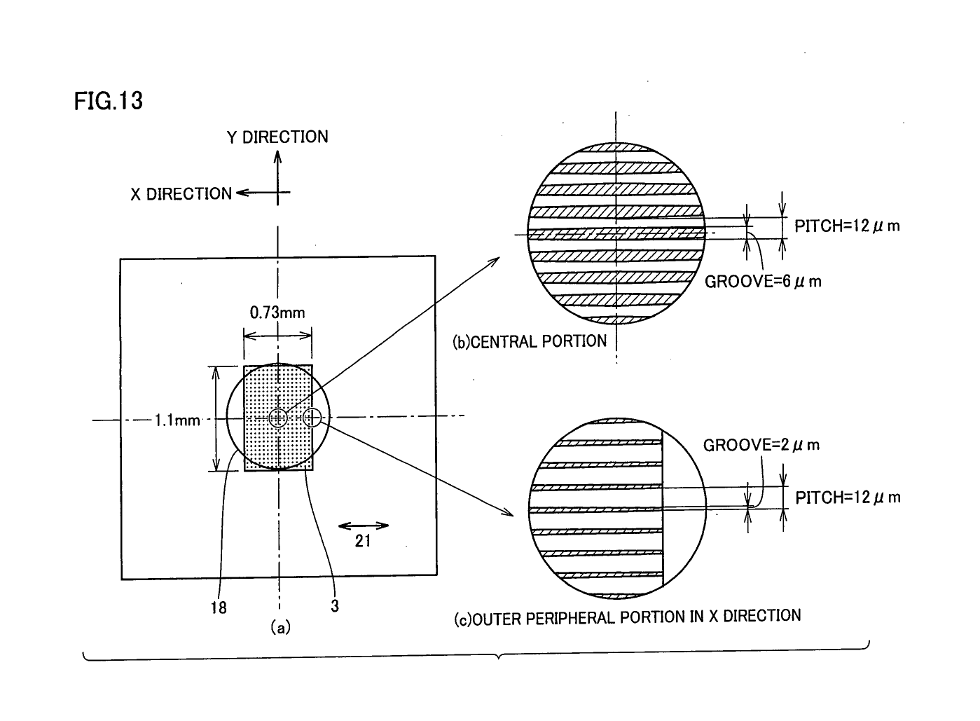

An optical pickup apparatus according to a third embodiment is described with reference to FIGS. 12A to 14.

In the present embodiment, as shown in FIG. 12A, diffraction grating 3 is disposed in a convergence optical path as the second embodiment. Therefore, supposing for example that L=8.1 mm and x=4.5 mm are used, φgr=1.1 mm is obtained as the second embodiment. Supposing that the whole half-width of the FFP of the light emitted from semiconductor laser 1 has a horizontal component of θ//=9° and a vertical component of θ⊥=18°, an irradiated region is elliptical in shape that is long in the Y direction and has a minor axis of 0.7 mm and a major axis of 1.43 mm. The effective diameter (φgr) at the position of the diffraction grating uses a central portion of the laser-irradiated region. It is noted that the present embodiment is configured by rotating semiconductor laser 1 of the first and second embodiments about the optical axis by 90°. Thus, the axis of polarization is also rotated by 90°. Therefore, the major axis of the FFP directed in the X direction (tracing direction) in the first and second embodiments is directed in the Y direction (track direction) in the present embodiment.

In the present embodiment, the grating pattern of diffraction grating 3 is the one as shown in FIG. 13 having the direction of grooves of the diffraction grating that is parallel to the X direction (tracking direction), and thus the groove region has a considerably long rhombus structure. Further, the L/G duty linearly changes in the X direction (tracking direction). The duty is close to 50% in the central portion and is close to 100% as the distance to the outer periphery decreases and the land ratio increases. On the contrary, the land region may be a considerably long rhombus structure and the groove region may be larger in the outer peripheral portion. In this case, the L/G duty is close to 0% in the outer peripheral portion. Semiconductor laser 1 is adjusted to be disposed about the optical axis in the manner that the plane of polarization of the emitted light is parallel to the direction of grooves of diffraction grating 3.

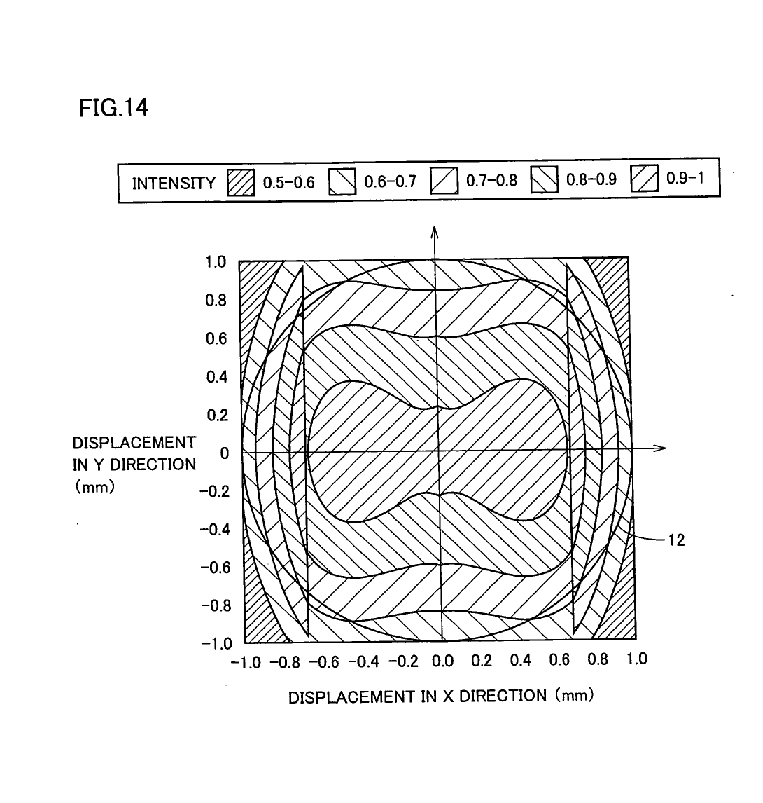

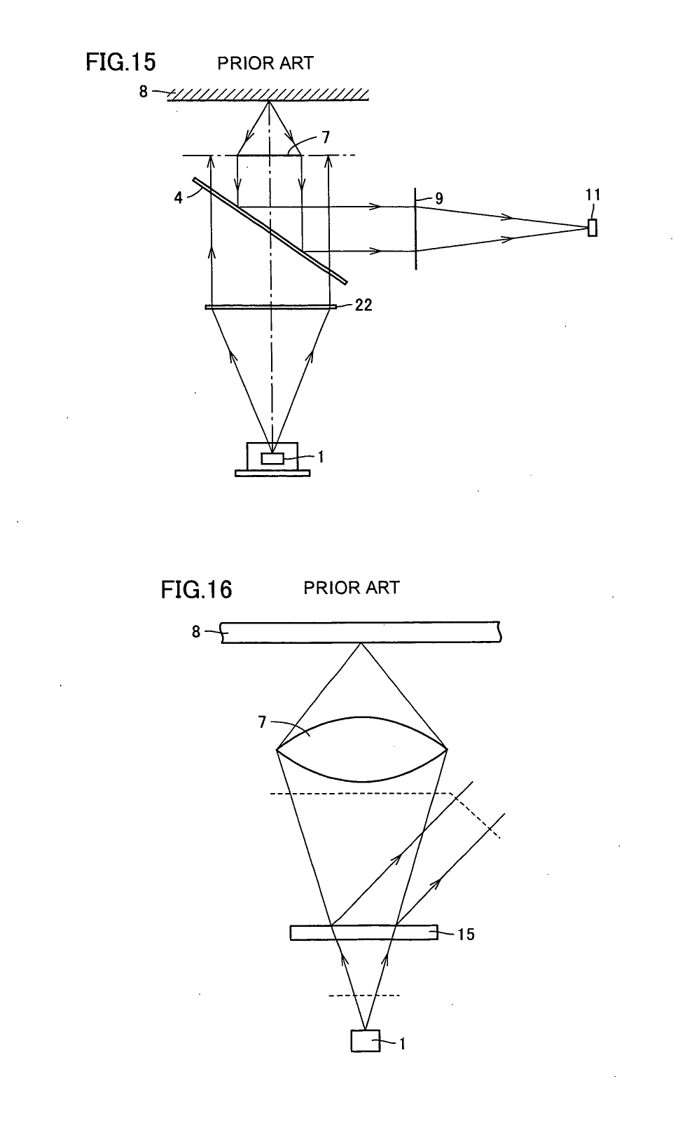

The intensity distribution of the light passed through diffraction grating 3 and thereafter emitted from collimate lens 2 is shown in the form of a graph in FIG. 14. Around the central part, iso-intensity distribution lines extend in the shape of a dumbbell and oriented in the X direction. Further, the line representing an intensity of 0.6 or higher is elliptical in shape oriented in the Y direction. This is for the reason that the FFP irradiation pattern in FIG. 12B is elliptical. At X=±0.7 mm, the borderline is shown because of the borderline of diffraction grating 3. Since the light is thus passed through diffraction grating 3, the Rim intensity in the X direction (tracking direction) can be increased from 40% to 60% as shown in FIG. 5 without a shaping prism through which the light is passed as used in the conventiona art. Further, the width (D) in the X direction of the diffraction region is set to φgr×0.6≦D≦φgr as the first embodiment, and thus a satisfactory intensity of the main beam applied to the objective lens can be ensured and further a satisfactory Rim intensity is met. Therefore, an optical system excellent in focusing characteristics of the objective lens can be designed.

Although photo-receiving element 11 in the second and third embodiments is illustrated in the form separately packaged from the package of semiconductor laser 1, it is not limited to the illustrated one. They may be mounted in the same package.

Further, in the first to third embodiments, simulation calculations are carried out under the condition that the L/G duty linearly changes from the central portion toward the outer periphery. However, particularly in the case where the line width is changed in the track direction as the first and second embodiments, an optimum profile for improving the coupling efficiency and the Rim intensity is not limited to the above-described one as long as the L/G duty continuously changes from the central portion toward the outer periphery. However, in the case where the line width is changed in the tracking direction as the third embodiment, it is desirable that the line width of the diffraction grating is linearly changed, since the advantages are obtained that the diffraction element provides less variations in producing the diffraction grating to achieve high productivity.

In accordance with the invention in the third embodiment, the optical pickup apparatus has the semiconductor laser adjusted to allow the plane of polarization of the light emitted from the light source to be perpendicular to the track direction of the optical disk and parallel to the direction of grating grooves of the diffraction grating, the light from the semiconductor laser is passed through the diffraction grating and the light splitting element and thereafter focused by the objective lens on the recording medium, the light reflected from the recording medium is passed through the objective lens and the light splitting element and thereafter coupled through the collective lens to the photo-receiving element, and accordingly record and servo signals on the optical disk are optically read. The grating constant of the diffraction grating is entirely uniform, the L/G duty continuously changes in the direction parallel to the grating grooves of the diffraction grating, and the L/G duty is set close to 50% in the central portion of the diffraction grating and close to 100% as the distance to the outer periphery decreases and the land ratio increases (close to 0% in the case where the groove ratio increases). Thus, without using such a component as shaping prism like that of the conventional art, the intensity of the Gaussian beam emitted from the semiconductor laser can be made flat. Accordingly, the focused spot on the optical disc can be made sufficiently small to improve the quality of a record signal and a reproduction signal.

Further, the zero-order light in and around the central portion that is reduced for producing the flat intensity of the Gaussian beam is converted by the diffraction grating into the ±first-order diffracted light to be used for tracking servo. Therefore, as compared with the conventional optical pickup, the light can be used efficiently.

Furthermore, the diffraction grating is disposed in the optical path from the semiconductor laser to the light splitting element and thus the diffraction grating can be disposed in the forward-travel path only. Therefore, as compared with the conventional optical pickup, light loss is decreased and the light can be used efficiently.

Moreover, the region of the diffraction grating is limited and thus a satisfactory intensity of the main beam to be applied to the objective lens can be ensured and a satisfactory Rim intensity is also met. Therefore, the optical system excellent in focusing characteristics of the objective lens can be designed.

It should be noted that the foregoing embodiments disclosed herein are by way of illustration and example in any respects, not to be taken by way of limitation. The technical scope of the present invention is defined by claims, not by the above embodiments only. Further, all variations and modifications in the meaning and scope equivalent to the claims are covered.

### INDUSTRIAL APPLICABILITY

In accordance with the present invention, the optical pickup apparatus can be provided that has a reduced number of components while the loss in light quantity in recording and reproduction can be minimized.

1. An optical pickup apparatus directing light from a semiconductor laser to an objective lens through a diffraction grating and a light splitting element, concentrating the light on an optical disc by said objective lens, and coupling the light reflected from said optical disc to a photo-receiving element through said objective lens and said light splitting element to optically read a record signal and a servo signal on said optical disc, wherein
said diffraction grating has an entirely uniform grating constant,
a duty ratio between a land (L) and a groove (G) (hereinafter L/G duty) continuously changes from a central portion in a direction orthogonal to grating grooves of said diffraction grating toward an outer peripheral portion of said diffraction grating in the direction orthogonal to the grating grooves of said diffraction grating, and
said diffraction grating satisfies a relation 0.6≦D/φgr≦1 between a diffraction region width D in the direction in which the L/G duty changes and an effective diameter φgr, at a diffraction grating position, of the light from said semiconductor laser.

2. The optical pickup apparatus according to claim 1, wherein
said L/G duty is defined by L/G duty (%)=L/(L+G)×100, said L/G duty is close to 50% in the central portion of said diffraction grating and close to 100% in the outer peripheral portion in a case where the ratio of the land increases as the distance to the outer peripheral portion decreases in the direction orthogonal to the grating grooves of said diffraction grating or close to 0% in the outer peripheral portion in a case where the ratio of the groove increases as the distance to the outer peripheral portion decreases in the direction orthogonal to the grating grooves of said diffraction grating.

3. The optical pickup apparatus according to claim 1, wherein
said semiconductor laser is disposed in a manner that a plane of polarization of light emitted from the laser is perpendicular to the direction of the grating grooves of said diffraction grating.

4. The optical pickup apparatus according to claim 1, wherein
said diffraction grating is provided on a plane on which light is incident or a plane from which light is emitted of a diffraction element, and said diffraction grating generates diffracted light used for tracking servo.

5. The optical pickup apparatus according to claim 1, wherein
said diffraction grating is disposed in an optical path from said semiconductor laser to said light splitting element.

6. (canceled)

7. The optical pickup apparatus according to claim 1, wherein
said diffraction grating satisfies a relation 1.8≦δc/δ≦2 between a diffraction efficiency δc of ±first-order light in a center part and a diffraction efficiency δ of ±first-order light of a whole effective light beam.

8. An optical pickup apparatus directing light from a semiconductor laser to an objective lens through a diffraction grating and a light splitting element, concentrating the light on an optical disc by said objective lens, and coupling the light reflected from said optical disc to a photo-receiving element through said objective lens and said light splitting element to optically read a record signal and a servo signal on said optical disc, wherein
said diffraction grating has an entirely uniform grating constant,
a duty ratio between a land (L) and a groove (G) (hereinafter L/G duty) continuously changes from a central portion in a direction parallel to grating grooves of said diffraction grating toward an outer peripheral portion of said diffraction grating in the direction parallel to the grating grooves of said diffraction grating, and
said diffraction grating satisfies a relation 0.6≦D/φgr≦1 between a diffraction region width D in the direction in which the L/G duty changes and an effective diameter φgr, at a diffraction grating position, of the light from said semiconductor laser.

9. The optical pickup apparatus according to claim 8, wherein
said L/G duty is defined by L/G duty (%)=L/(L+G)×100, said L/G duty is close to 50% in the central portion of said diffraction grating and close to 100% in the outer peripheral portion in a case where the ratio of the land increases as the distance to the outer peripheral portion decreases in the direction parallel to the grating grooves of said diffraction grating or close to 0% in the outer peripheral portion in a case where the ratio of the groove increases as the distance to the outer peripheral portion decreases in the direction parallel to the grating grooves of said diffraction grating.

10. The optical pickup apparatus according to claim 8, wherein
said semiconductor laser is disposed in a manner that a plane of polarization of light emitted from the laser is parallel to the direction of the grating grooves of said diffraction grating.

11. The optical pickup apparatus according to claim 8, wherein
said diffraction grating has a land width and a groove width that linearly change from the central portion toward the outer peripheral portion.

12. The optical pickup apparatus according to claim 8, wherein
said diffraction grating is provided on a plane on which light is incident or a plane from which light is emitted of a diffraction element, and said diffraction grating generates diffracted light used for tracking servo.

13. The optical pickup apparatus according to claim 8, wherein
said diffraction grating is disposed in an optical path from said semiconductor laser to said light splitting element.

14. (canceled)

15. The optical pickup apparatus according to claim 8, wherein said diffraction grating satisfies a relation 1.8≦δc/δ≦2 between a diffraction efficiency δc of ±first-order light in a center part and a diffraction efficiency δ of ±first-order light of a whole effective light beam.
